(19) United States
(12) Patent Application Publication
(10) Pub. No.: US 2011/0307277 A1
(43) Pub. Date: Dec. 15, 2011

(54) COMPUTER IMPLEMENTED RISK AND INSURANCE NEEDS ASSESSMENT SYSTEM AND METHODS

(75) Inventors: Debra Cruz, Mount Vernon, NY (US); Kevin M. Kelley, Chatham, NJ (US)

(73) Assignee: Metropolitan Life Insurance Company, Long Island City, NY (US)

(21) Appl. No.: 12/797,235

(22) Filed: Jun. 9, 2010

(51) Int. Cl. G06Q 40/00; G06F 17/00

(52) U.S. Cl. 705/4; 715/221

(57) ABSTRACT

Disclosed herein are systems and methods for assessing and recommending a life insurance package to a client. A life insurance package may comprise the amount of life insurance coverage and the monthly cost needed to obtain that amount of coverage. In an exemplary embodiment, two or more life insurance packages, including what each life insurance package covers, are presented to the user. In an exemplary embodiment, default assumptions are made for questions that are difficult for the user to answer but may be fairly accurately estimated by the system.

### TECHNICAL FIELD

Various embodiments of the present invention relate to computer systems for managing and assessing risk addressable with life insurance and, more particularly, to selectively programmed computer systems and software based methods for collecting, organizing and assessing personal financial risk so that an enhanced and optimized amount of life insurance may be proposed. The system provides a powerful front end to the computer based underwriting system described in U.S. patent application Ser. No. 12/542,500, entitled “Online System and Method of Insurance Underwriting” filed by the assignee of the present invention and incorporated herein by reference.

### BACKGROUND

In the event of a person's passing, that person's survivors, including family, can face financial stresses and related difficulties based on the particular circumstances of the survivors. Life insurance is a long recognized technique that provides money directly to the deceased's beneficiaries which can be used for anything including, making up for lost income, funding a child's education, paying off debt, and/or paying funeral expenses.

While various options exist for providing for one's survivors, many of these options are insufficient for adequately protecting the survivors. For example, while some employers may provide life insurance, the benefit amount of that insurance may be insufficient to meet one's survivors' needs. Personal, retirement, or education savings or a home equity loan can be quickly depleted and insufficient for the survivors' needs, and reliance on these savings can negatively affect future plans. A home equity loan can quickly deplete long sought equity in one's property. A credit card cash advance can impose high interest rates, leading to further financial difficulties in the future. Life insurance, in contrast to the above options, can guarantee a payment when it is most needed without negatively impacting the survivors' future plans.

Of course, life insurance can be costly. Too much insurance can impair current financial conditions of a family by diverting funds from other long standing needs including savings for retirement and education. Determining the proper amount of life insurance is a complex task that has become even more daunting for many as other financial planning responsibilities have been relegated to the individual. Today, a typical family must responsibly plan for housing costs, retirement savings, educational expenses and an increasing portion of health care costs.

Therefore, there is a growing need for an effective tool to assist in assessing personal financial risk and to facilitate the selection of one or more optimal levels of coverage and the estimated costs associated with these levels of coverage. In an exemplary embodiment, a life insurance assessment system manages the collection of information necessary to assess policy planning needs for an individual and, based thereon, to identify an appropriate amount of life insurance coverage, and the projected monthly cost for that amount of coverage. For the specification, the term “life insurance package” comprises an amount of life insurance coverage and the monthly projected cost for that amount of coverage, and these amounts are understood to be estimates.

Although life insurance “calculators” exist, these calculators suffer from a number of shortcomings. For instance, calculators that attempt to be accurate query the user for large amounts of complicated information typically trigger a low response rate. Users facing questions too numerous or difficult simply will withdraw from the assessment or provide information of questionable accuracy. Calculators that attempt to simplify the process, on the other hand, are generally inaccurate due to the lack of information obtained.

In building the present invention, the inventors closely studied existing prior art calculators noting the above and other distinct problems with the approaches undertaken it the prior art. The present invention seeks to cure the deficiencies present in the prior art by using a number of techniques including, but not limited to the combination of simple yet highly relevant questions, selectively presenting these questions in a pre-defined order, generating follow-up questions based on previous answers, using default assumptions for difficult questions, and limiting the number of questions that require the user to estimate their answers.

### SUMMARY

Briefly described, various embodiments of the present invention are systems to facilitate the process in assessing client needs and to propose an optimized selection of insurance programs. In one embodiment, the system provides a counter-intuitive needs analysis, foregoing traditional costs/price focused metrics of the prior art. In particular, in one arrangement the present system, instead of focusing on how much insurance an individual can afford as a guiding parameter, the protocol focuses on the individuals needs based on commitments.

In operation, an assessment system, according to an exemplary embodiment of the present invention, implements a selectively arranged query algorithm comprised of a short string of balanced questions engineered to achieve a high response rate from users while providing an accurate measure of true client needs in terms of financial risk/exposure addressable by life insurance. For the purposes of this disclosure, the term “client” refers to a person for whom a life insurance recommendation is sought, while the term “user” refers to a person utilizing the assessment system to determine an appropriate recommendation. The user and the client can, but need not, be the same person. For example, a client can access the assessment system directly to receive a recommendation, or a user can use the assessment system on behalf of the client. For example, the user can be an insurance agent assisting the client in identifying appropriate insurance coverage.

An exemplary assessment system can comprise a query unit, an assessment unit, and a recommendation unit. Operation is accomplished on a network based computer system that permits interactive review of educational materials presented on screen, and selectively programmed queries presented on a display with entry of associated responses through keyboard, touchpad or similar. Other input techniques can be employed including voice response, mouse, hand motions or the like.

The query unit is programmed to generate user customized information requests in the form of prompts related to subjects that are selected to determine with a high degree of accuracy an optimized level of life insurance. For each prompt, the query unit can provide two or more response choices from which the user can choose or the query unit can provide a blank field for the user to enter a response. The user's responses are tracked by the query unit and the query unit provides additional questions based on the received response choices. For example, if the user enters the response “yes” to the question “do you have children”, the query unit may prompt the user with additional questions relating to the children.

The assessment unit is linked to and in communication with the query unit and calculates a “needs assessment value” based on the user's responses to the prompts. Each response can be assigned a needs assessment value or a number of responses can be used to calculate a needs assessment value. In an exemplary embodiment, the assessment unit can calculate needs assessment values for one or more categories, such as the amount needed to pay off the user's debt.

The recommendation unit is in communication with the assessment unit and recommends a life insurance package to the user based on the needs assessment values. In a preferred embodiment, the recommendation unit is programmed to provide a two tiered response based on the results obtained. The first tier presented by the recommendation unit is a full-protection life insurance package designed to cover a financially acceptable amount of the client's important needs. In addition to the optimized level, the system provides a second life insurance package that involves a lower level of coverage but at a reduced cost to the insured. In this arrangement, the recommendation unit depicts the level of coverage and/or gaps to the coverage for each life insurance package. The determination of these two levels addresses the expected needs of the vast majority of insurance customers. In addition, the lower level of insurance is optionally selected to correspond and/or satisfy the computer based underwriting level limits discussed in the above noted co-pending patent application.

Accordingly, the assessment system can use the user's responses to the presented prompts to recommend one or more appropriate life insurance packages. These and other objects, features, and advantages of the present invention will become more apparent upon reading the following specification in conjunction with the accompanying drawings.

### BRIEF DESCRIPTION OF THE FIGURES

FIG. 1 illustrates a block diagram of an assessment system and associated devices, according to an exemplary embodiment of the present invention.

FIG. 2 illustrates a computer architecture for a computing device configured to implement the assessment system, according to an exemplary embodiment of the present invention.

FIG. 3 illustrates a flow diagram of a method for recommending one or more life insurance packages, according to an exemplary embodiment of the present invention.

FIG. 4 illustrates a form presenting prompts and response choices to the user for recommending a life insurance package, according to an exemplary embodiment of the present invention.

FIG. 5 illustrates a form presenting prompts and blank fields to the user for recommending a life insurance package, according to an exemplary embodiment of the present invention.

FIG. 6 illustrates default assumptions for recommending a life insurance package, according to an exemplary embodiment of the present invention.

FIG. 7 illustrates a plurality of life insurance packages that can be recommended based on the user's responses to the prompts, according to an exemplary embodiment of the present invention.

### DETAILED DESCRIPTION

To facilitate an understanding of the principles and features of embodiments of the present invention, those principles and features are explained with reference to their implementation in illustrative embodiments. In particular, embodiments of the invention are described in the context of being assessment systems for assessing and recommending life insurance packages based on a user's responses to presented prompts. A life insurance package, in an exemplary embodiment, can be the amount of insurance coverage recommended or the minimum amount of insurance coverage recommended and can include the projected monthly cost for that amount of coverage. Embodiments of the invention, however, are not limited to selecting life insurance packages. Rather, embodiments of the invention can select other types of insurance products or provide various other types of recommendations.

The components described hereinafter as making up various elements of the invention are intended to be illustrative and not restrictive. Many suitable components that would perform the same or similar functions as the components described are intended to be embraced within the scope of the invention. Such other components can include, for example, components developed after development of the invention.

Referring now to the figures, in which like reference numerals represent like parts throughout the views, life insurance assessment systems and methods will be described in detail.

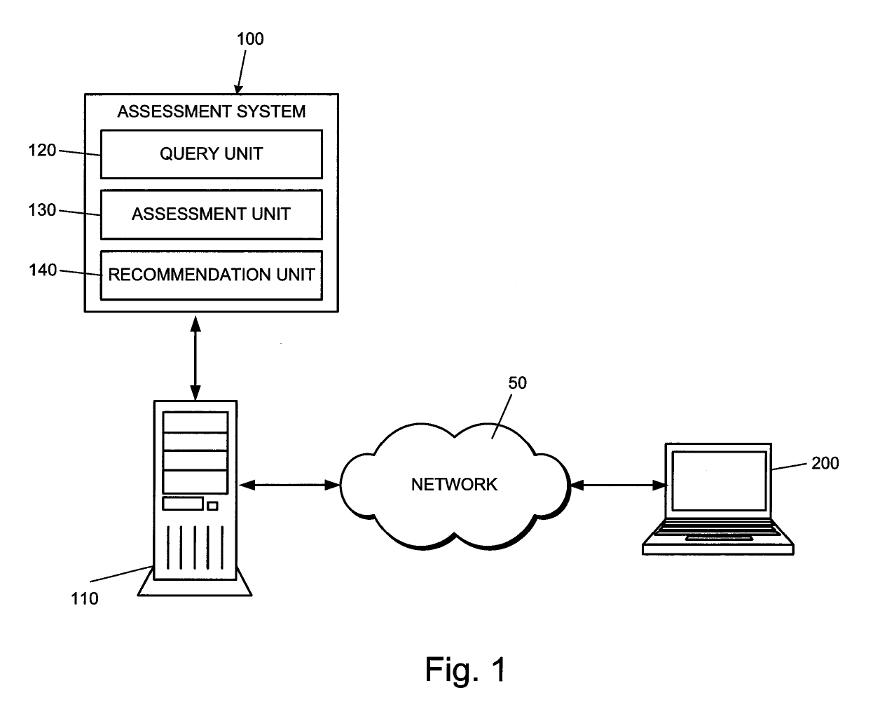

FIG. 1 illustrates a block diagram of an assessment system 100, according to an exemplary embodiment of the present invention. According to some embodiments of the present invention, an assessment system 100 can assess and recommend a life insurance package based on the user's responses to two or more prompts related to life insurance. Prompts related to life insurance can be, for example, any information related to present and future expenses or earnings, related to the client or his/her survivors. The assessment system 100 can be integrated, in whole or in part, into a computing device 200. The assessment system 100 can be in many forms, including a local software application, a remote application accessed by a web client, one or more hardware components, or a combination of these.

If the assessment system 100 is implemented as part of a web application, then the assessment system 100 can be operated remotely, such as by a server 110. The server 110 can be configured to service a website or otherwise communicate data to be displayed on the computing device 200. In that case, data entered into a user interface of the assessment system 100 that is displayed on the computing device 200 can be transmitted back to the server 110 for processing. Accordingly, the computing device 200 and the server 110 can communicate with each other for operation of the assessment system 100.

As shown in FIG. 1, the assessment system 100 can comprise one or more units for operation of various tasks of the assessment system 100. These units of the assessment system 100 can be modules, applications, devices, systems, services, or combinations or portions thereof. The units of the assessment system 100 can include a query unit 120, an assessment unit 130, and a recommendation unit 140.

Although these units of the assessment system 100 are shown, in FIG. 1, as being embodied at the server 110, one or more components of the assessment system may be operated on the local computing device 200. Further, although the units 120, 130, and 140 are depicted as being distinct units of the assessment system 100, this need not be the case. Components of the assessment system 100, including the query unit 120, the assessment unit 130, and the recommendation unit 140, can be integrated into a seamless system or can overlap as desired by developers or administrators of the assessment system 100.

The units 120, 130, and 140 of the assessment system 100 can be in communication with one another for operation of the assessment system 100. The query unit 120 can present to a user two or more prompts related to life insurance. For each prompt, the query unit 120 can provide two or more response choices from which the user can choose or provide a blank input field. The user can select or input his or her desired responses, which can be tracked or received by the query unit 120.

The assessment unit 130 can be in communication with the query unit 120 and can calculate one or more needs assessment values based on the user's responses to one or more prompts. The needs assessment values can be based on categories of needs such as the amount needed to pay off loans, the amount needed to fund a child's future college expenses, the amount needed to generate sufficient income, the amount needed to replace what the user does at home (such as child care), etc. The needs assessment values do not need to correspond directly to the amounts entered by a user. The assessment unit 130 may, for example, take into account future interest earnings/expenses, etc. In a preferred embodiment, the needs assessment calculations and determination of life insurance packages is performed on server 110 and the results sent to computing device 200.

Potential users of the assessment system 100 may be directed to the system 100 via advertisements on various websites. The advertisements may be strategically placed using an advertisement placement service.

The assessment system 100 may be used in conjunction with “Online System and Method of Insurance Underwriting” (U.S. patent application Ser. No. 12/542,500).

The recommendation unit 140 can be in communication with the assessment unit 130 and/or the query unit 120 and can recommend one or more life insurance packages to the user based on the user's responses and/or the needs assessment values. Accordingly, the query unit 120, the assessment unit 130, and the recommendation unit 140 can operate in conjunction with one another to select and recommend appropriate life insurance packages for the user.

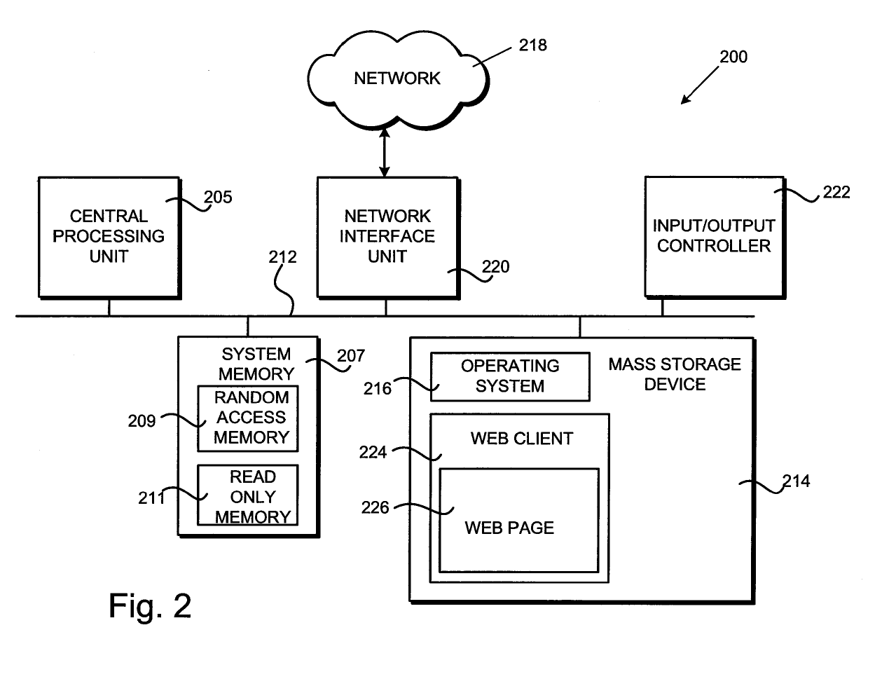

FIG. 2 illustrates a computer architecture for a computing device 200 configured to implement an assessment system 100, according to an exemplary embodiment of the present invention. Those skilled in the art will recognize that the general architecture described with reference to FIG. 2 is provided for example only, and can be modified to accommodate various embodiments and operational environments of the assessment system 100.

As shown in FIG. 2, the computing device 200 can comprise a central processing unit 205 and one or more system memories 207, such as a random access memory 209 (“RAM”) and a non-volatile memory, such as a read-only memory (“ROM”) 211. The computing device 200 can further comprise a system bus 212 coupling together the memory 207, the processing unit 205, and various other components. A basic input/output system containing routines to assist in transferring information between components of the computing device 200 can be stored in the ROM 211. Additionally, the computing device 200 can include a mass storage device 214 for storing an operating system 216, application programs, and other program modules.

The mass storage device 214 can be connected to the processing unit 205 through a mass storage controller (not shown) connected to the bus 212. The mass storage device 214 and other computer-readable media can comprise computer storage media, which can include volatile and non-volatile, removable and non-removable media implemented in any method or technology for storage of information, such as computer-readable instructions, data structures, program modules, or other data. Computer storage media includes, but is not limited to, RAM, ROM, EPROM, EEPROM, flash memory, other solid state memory technology, CD-ROM, digital versatile disks (“DVD”), other optical storage, magnetic cassettes, magnetic tape, magnetic disk storage, other magnetic storage devices, or various other media used to store data accessible by the computing device 200.

A number of program modules and data files can be stored in the computer storage media and RAM 209 of the computing device 200. Such program modules and data files can include an operating system 216 suitable for controlling operations of a networked personal computer. A web browser application program, or web client 224, can also be stored on the computer storage media and RAM 209. The web client 224 may comprise an application program for requesting and rendering web pages 226 created in Hypertext Markup Language (“HTML”) or other types of markup languages. The web client 224 can be capable of executing scripts through the use of a scripting host. The scripting host executes program code expressed as scripts within the browser environment.

Computer-readable instructions on the storage media of the computing device 200 can include, for example, instructions for implementing processes of the assessment system 100 or for implementing a web client 224 for receiving instructions from the assessment system 100 when operated remotely. These instructions can be executed by the processing unit 205 to enable use of the assessment system 100. If a server 110 operates the assessment system 100 remotely from the computing device 200 on which a user interface of the assessment system 100 is displayed, then a processing unit 205 at the server 110 can execute instructions on computer storage media accessible by the server 110 for operating processes of the assessment system 100.

The computing device 200 can operate in a networked environment using logical connections to remote computers, such as the server 110, over a network 50, such as the Internet. The computing device 200 can connect to the network 50, the server 110, and other remote computers through a network interface unit 220 connected to the bus 212.

The computing device 200 can also include an input/output controller 222 for receiving and processing input from a number of input devices, including a keyboard, mouse, or electronic stylus. Interactions between the input devices and a user interface of the assessment system 100 can be detected by the input/output controller 222 to interpret input to the assessment system 100. The input/output controller 222 can additionally provide output, which can be displayed on the user interface of the assessment system 100 and which can provide one or more prompts and response choices of the assessment system 100. The output is provided to a display screen.

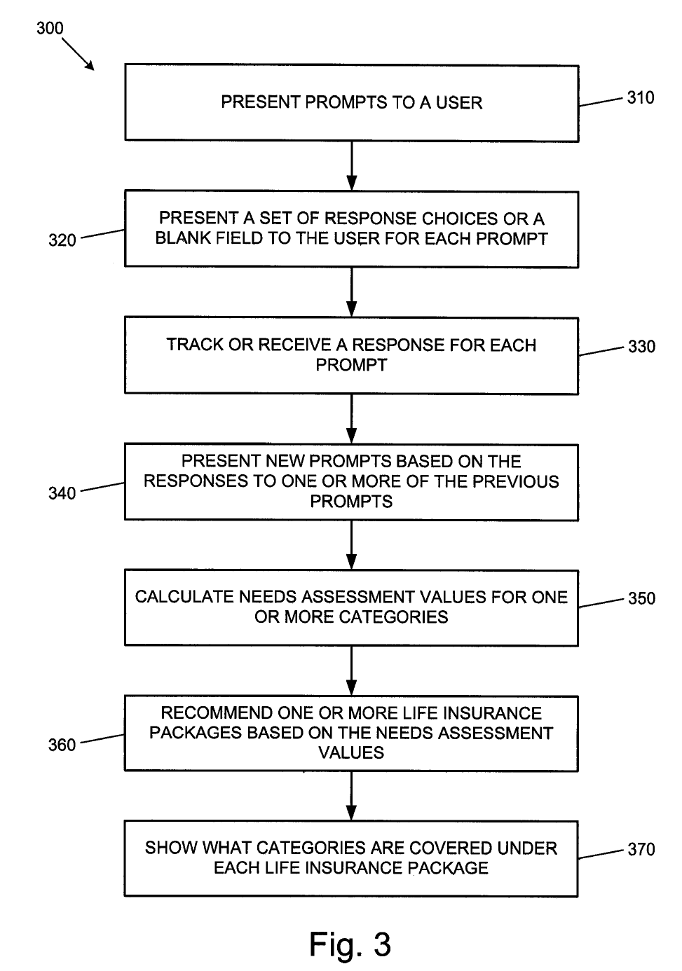

FIG. 3 illustrates a flow diagram of a method 300 for recommending one or more life insurance packages 710 and 720, according to an exemplary embodiment of the present invention. The method 300 of FIG. 3 is presented for illustrative purposes only, however, and does not limit the scope of the assessment system 100, which can employ various methods to recommend life insurance packages in accordance with the present invention.

As shown in FIG. 3, one or more prompts 310 can be presented to the user, and the prompts can be designed to reveal relevant information about the user's needs for life insurance. At 320, one or more sets of response choices or a blank field can be presented to the user, where each set of response choices or blank field corresponds to a particular prompt 310. At 330, responses for each prompt can be tracked or received from the user. For the purposes of this specification, the term “received” is inclusive of the term “tracked”. At 340, new prompts can be presented to the user based on received responses 330 to one or more of the previous prompts 310. Steps 310 to 340 may be repeated. At 350, needs assessment values are calculated for one or more categories based on one or more received responses 330. At 360, a one or more life insurance packages are recommended to the user based on the needs assessment values 350 and/or responses 330. Finally, at 370, for each life insurance package recommended, it is shown what that life insurance package covers.

Questions or prompts relating to the client and his or her survivors used to assess and recommend a life insurance package may include, but are not limited to, the following: date of birth, gender, state of residence, whether client has a spouse or partner, whether client has children, whether client has a mortgage, whether client provides health insurance for his or her family, number of children, children's ages, children's college goals (ex. private, in-state public, out-of-state public, no college), outstanding balance of mortgage, monthly payments for mortgage, outstanding debt balance (including credit cards, auto, student loans, etc.), whether client is the primary earner, annual income, planned age of retirement, available assets (ex. savings, life insurance already owned, etc.), yearly cost of health insurance, yearly cost to replace what client does at home (cleaning, child care, etc.), yearly personal expenses, and taxes paid on income.

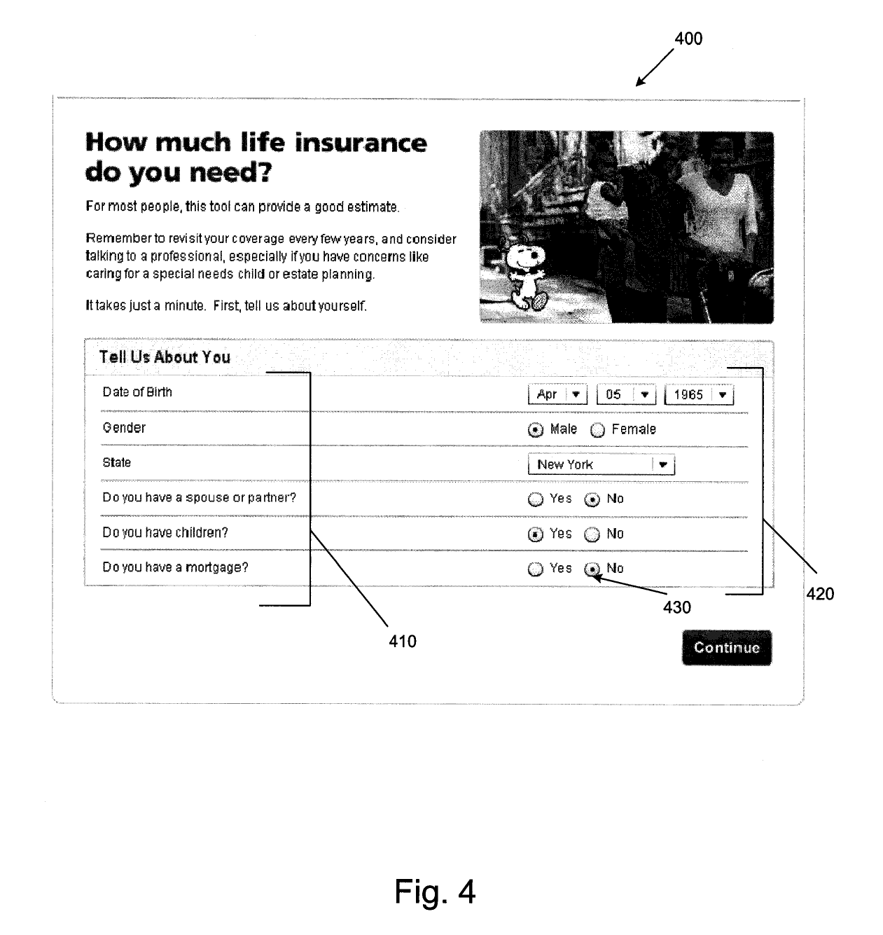

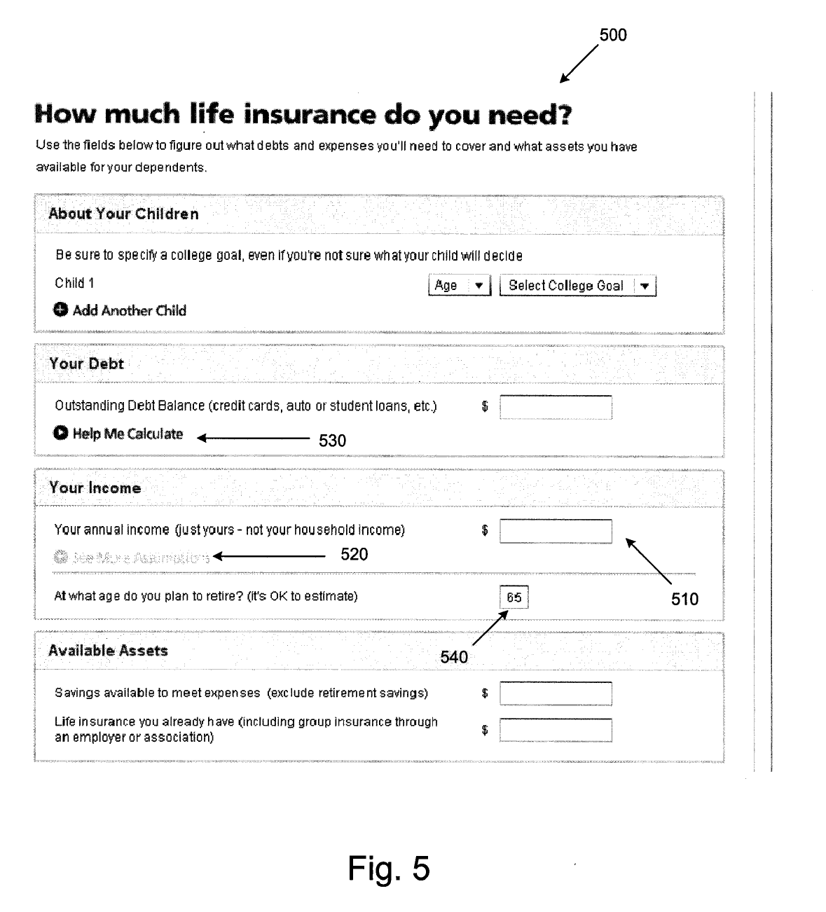

FIG. 4 illustrates a form presenting prompts and response choices to the user for recommending a life insurance package, according to an exemplary embodiment of the present invention. Blank fields may be used instead of predefined response choices, as seen in FIG. 5. In one embodiment, such as FIG. 4, the first prompts presented to a user are filtering questions asked to determine which further questions to ask.

As shown in FIG. 4, a form 400 of the assessment system 100 can comprise a predetermined set of prompts 410 and response choices 420 presented to a user for recommending a life insurance package. In a preferred embodiment, the form 400 is an electronic form presented to the user in a graphical user interface of the assessment system 100. The user can read the prompts 410 from the graphical user interface and can select a response choice 430 through the graphical user interface. For example, to select a desired response choice 430, the user can utilize an input device to select the desired response choice 430, such as by positioning a mouse cursor of the desired response choice 430 and clicking a mouse button. When the user has completed the form 400, the user can submit his or her answer choices 420, such as by clicking a “save” or “submit” button. The query unit 120 can track or receive the user's responses 420 through the graphical user interface, and the assessment system 100 can store the responses 420 for later use. In an exemplary embodiment, the responses 420 can be used to calculate a needs assessment value. In an exemplary embodiment, the responses 420 can be used to generate new prompts based on the tracked or received responses 420. For example, based on the user's response to the questions “do you have children” and “do you have a mortgage”, further prompts can be generated. This feature can be seen in the transition from FIG. 4 to FIG. 5. The responses in FIG. 4 indicate that the client has children, but has no mortgage; thus, the following page, FIG. 5, prompts the user about his or her children, but not about a mortgage. In an exemplary embodiment, prompts may be dynamic and appear on the current page in response to a tracked or received response. For example, a prompt asking a child's age appearing in response to the user clicking the “yes” button relating to the prompt asking whether the client had children.

Each presented prompt 410 in the form 400 can relate to life insurance and can have a corresponding set of predetermined response choices 420 or blank fields 510. Prompts relating to life insurance can be any questions designed to help assess the needs, based on present and predicted future expenses/incomes, of the client and his or her survivors. Prompts relating to life insurance can include questions relating to income, mortgage, children, date of birth, gender, state, spouse/partner, debts, assets, health, occupation, etc. In an exemplary embodiment, only simple prompts requiring simple responses are presented. In an exemplary embodiment, prompts that will likely require a user to estimate his or her answer will be limited. In another exemplary embodiment, prompts that will likely require a user to estimate his or her answer will be eliminated.

In one embodiment, the assessment system 100 can select recommended insurance packages from a wide variety of potential packages. The specific prompts 410 presented to the user can depend on the life insurance packages available for recommendation, and can further depend on how these available packages compare to one another. In the preferred embodiment, the “insurance packages” comprise the amount of coverage recommended and the projected monthly cost for that amount of coverage.

If a particular prompt 410 is presented in the form of a question, then the response choices 420 can be potential answers to the question, or a blank field 510 can be provided. In some embodiments, a set of response choices 420 corresponding to a particular prompt 410 can include one or more of the following response choices: true, false, unsure and maybe.

FIG. 5 illustrates a form presenting prompts and blank fields to the user for recommending a life insurance package, according to an exemplary embodiment of the present invention.

As shown in FIG. 5, a form 500 of the assessment system 100 can comprise a blank field 510 presented to the user for recommending a life insurance package. Blank field 510 may be programmed such that only a certain range or type of answer is accepted. For example, only numbers are accepted for a prompt about income. As discussed above, the questions asked after the initial screening questions in FIG. 4 are based on the responses to the previous prompts. Prompts about children are included in FIG. 5 because the previous response in FIG. 4 indicated that the client had children. Likewise, prompts relating to a mortgage are not included in FIG. 5 because the previous response in FIG. 4 indicated the client did not have a mortgage. Prompts relating to children can be used to determine when a child may be going to college, and the estimated cost of college (for example, private vs. public schools, or no college goals). Prompts relating to mortgages can include the current outstanding debt, interest rates, and/or amount of monthly payments. Prompts relating to income can be used to determine the amount of money that needs to be generated in order to replace the client's income. However, not all of the client's income needs to be replaced; for example, certain tax situations may decrease the need of income that needs to be replaced, whereas health insurance and the amount needed to replace what you do at home would increase the amount of income needed. In an exemplary embodiment, the amount of income needed to be replaced is calculated by the assessment unit as a needs assessment value. Furthermore, the assessment unit may calculate more than one needs assessment value for the amount of income needed to replaced; for example, an ideal level of income and a minimum level of income needed to be replaced. In one embodiment, prompts can be used to determine social security survivor benefits.

In one embodiment, certain prompts have associated with them a calculator 530 to assist the user in determining a response. This may be used, for example, to add different types of debt (credit card, loans, etc) together to answer a prompt asking the user his or her total debt. In an exemplary embodiment, prompts which are difficult for users to answer, but may be fairly accurately estimated by the assessment system, are given a default value. For example, a default value 540 is given for age of retirement, since many people may have a hard time estimating when they will retire, but the assessment system can reasonably use, as a default, the common retirement age of 65.

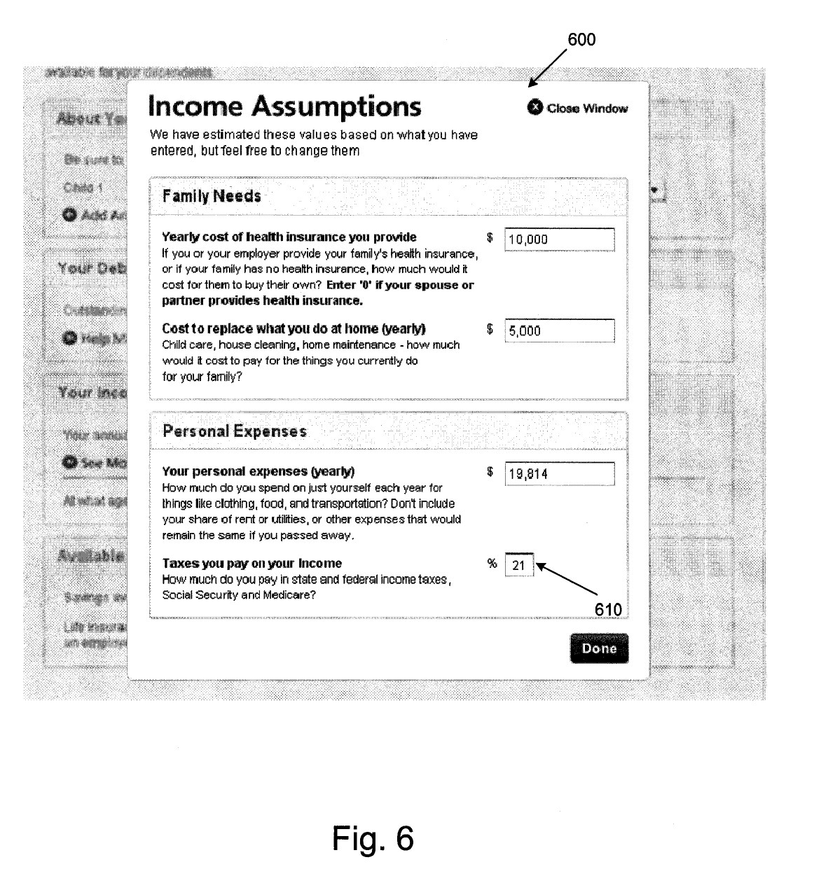

FIG. 6 illustrates default assumptions for recommending a life insurance package, according to an exemplary embodiment of the present invention.

In an exemplary embodiment, assessment system 100 provides for calculations based on default assumptions, such as income assumptions 600. These assumptions allow for a simpler and more enjoyable experience for the user, while maintaining a reasonable degree of accuracy. Additionally, some assumptions are calculated based on the user's responses. For example, a client's marginal tax rate is assumed 610 by the assessment system 100, based on the client's response to the amount of income prompt. These assumptions are only defaults and may be changed by the user, for example, by clicking assumptions button 520. Assumptions may be made for any amount that can be fairly accurately estimated, and is especially useful for questions that users do not generally think about, such as the cost needed to replace what they do at home (taking care of kids, cleaning, home maintenance, etc). Assumptions are also useful, where they can be fairly accurately estimated, for questions which users may simply have a hard time estimating, such as health insurance costs and yearly personal expenses. Such questions are often trouble areas in prior art calculators. Calculators that include questions that require the user to estimate amounts often frustrate the user into not completing the assessment because of the difficulty and annoyance of these estimations. The calculators that leave out these questions, however, are inaccurate. Furthermore, according to studies conducted in the development of the present invention, users tend to provide very inaccurate estimations. These studies also indicated that while the present invention's assumptions were not always completely accurate, they tended to be more accurate than estimations provided by users. Calculators with questions requiring estimations thus, in addition to causing users to abandon the calculator, tend to sabotage the results with the inaccurate estimations provided by the users.

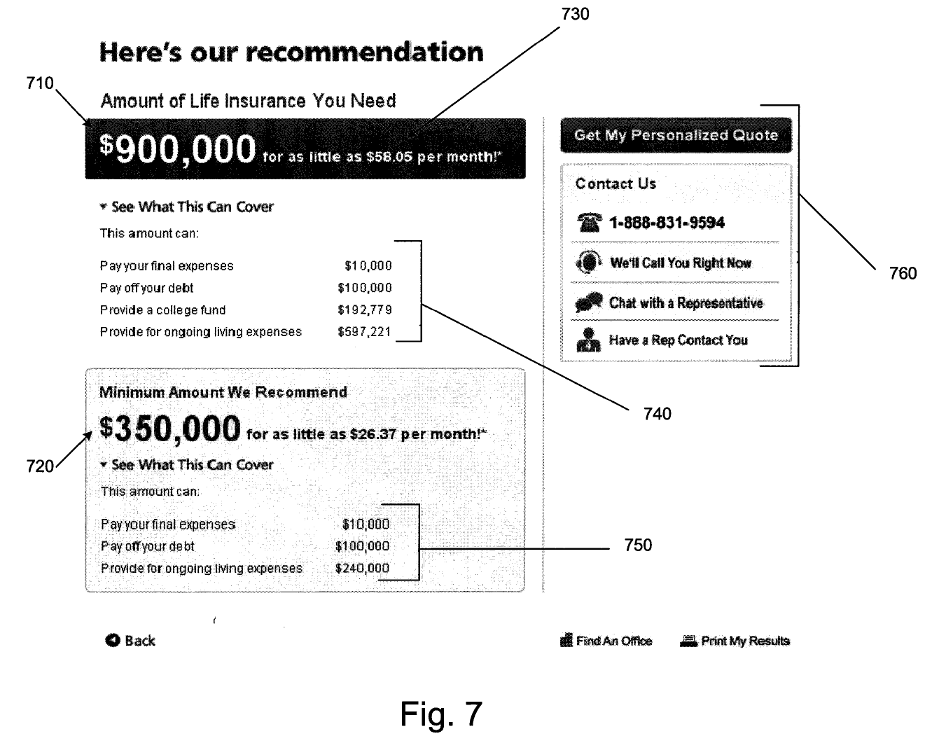

FIG. 7 illustrates a plurality of exemplary available life insurance packages 710 and 720 that can be recommended based on the user's responses to the prompts. The available insurance packages 710 and 720 depicted in FIG. 7 are presented for illustrative purposes only and do not limit the type or quantity of insurance packages that can be made available for recommendation through the assessment system 100.

As shown in FIG. 7, life insurance packages 710 and 720 are presented to the user. In one embodiment, shown in FIG. 7, two life insurance packages are presented, each life insurance package comprising the amount of coverage and the estimated cost per month 730 required to obtain that amount of coverage. In a preferred embodiment, as shown in FIG. 7, a first life insurance package represents a full-protection life insurance package 710 designed to cover an optimized amount of the client's important needs, and a second life insurance package represents a less expensive life insurance package 720 that covers less of the client's needs than the full-protection package, but at a lower cost to the insured. In one embodiment, the lower level of insurance 720 is optionally selected to correspond and/or satisfy the computer based underwriting level limits or thresholds discussed in the above noted co-pending patent application.

In one embodiment, a less expensive life insurance package is only displayed when it is at least $100 k less than the full-protection life insurance package, and no life insurance packages are displayed when a threshold coverage amount of $100 k is not met. In one embodiment, life insurance packages are not calculated without the client's income. According to research conducted in the development of the present invention, a common reaction to the recommended amount of life insurance coverage is “sticker shock” or surprise at the amount of coverage recommended. The present invention helps alleviate sticker shock by providing a cost quote immediately, providing a minimum recommended amount, and breaking down by category what the particular amount of coverage will cover, as seen in 740 and 750. The breakdown of coverage may show, for example, that a full-protection life insurance package 710 could cover final expenses (such as funeral expenses), pay off the client's debt, provide a college fund, and provide ongoing living expenses. Whereas the breakdown of coverage for a less expensive life insurance package 720 may show that it does not provide for a college fund, and might provide less for ongoing living expenses. In a preferred embodiment, the breakdown of coverage includes an estimate of the amount each item will cost to be covered. The assessment system's 100 defense of the amount of coverage is an important feature, as it makes it clear to the user why the client needs the amount of coverage the system recommends, and validates the systems recommendations.

The assessment system 100 also provides for follow-up features 760 after the life insurance packages have been presented. These follow-up features 760 can be used to generate an immediate transaction between an insurance company and the client. For example, an online user could click a button to get a more personalized quote by entering more details about the client's health and desired policy terms. This detailed quote button could direct the user to another web portal or the tool could be embedded in the assessment system 100. Additionally, information already answered in the assessment system 100 could be automatically populated as responses for the personalized quote. The user could also have a representative call them by entering their phone number into the system, call the number of the insurance company listed, or chat online instantly with a representative.

Accordingly, as described above, various embodiments of life insurance assessment systems 100 and methods 300 according to the present invention can assess and recommend life insurance packages 710 and 720 based on responses to prompts presented by the assessment system 100.

While various exemplary embodiments of assessment systems 100 and methods 300 have been disclosed and illustrated in detail, many modifications, additions, and deletions can be made to the reporting systems without departing from the spirit and scope of the present invention and its equivalents, as set forth in the following claims.

What is claimed is:

1. A computer-implemented method for assessing and recommending life insurance, the method comprising:
presenting a series of inquires selectively arranged to facilitate information collection regarding client needs in the form of one or more prompts related to life insurance;
receiving, in a computer, a series of responses to the inquires wherein said responses to said prompts provides a risk profile for said client based on one or more financial commitments of said client;
computing, with a computer processor, one or more needs assessment values based on the received responses; and
recommending one or more life insurance packages based on said one or more needs assessment values.

2. The method of claim 1, wherein said prompts related to life insurance comprise questions relating to at least one of a client's, present or future, expenses or earnings.

3. The method of claim 1, wherein said one or more life insurance packages comprises an amount of coverage and the projected monthly cost for obtaining said amount of coverage.

4. The method of claim 3, wherein said one or more needs assessment values are computed by category, said categories comprising one or more of the following: cost to pay off debt, cost of children's education, cost to pay off mortgage, cost to provide ongoing living expenses, and final expenses.

5. The method of claim 3, wherein said recommended one or more life insurance packages includes at least one full-protection package, and at least one package less expensive than said full-protection package.

6. The method of claim 5, further comprising presenting what each said recommended one or more life insurance package covers.

7. The method of claim 6, further comprising presenting an estimate of the amount each said covered item will cost to be covered.

8. The method of claim 1, wherein less than 35% of said prompts likely require a user to estimate a number.

9. The method of claim 1, wherein said prompts do not include prompts likely to require a user to estimate a number.

10. The method of claim 1, further comprising a first page of said prompts that provides filtering questions, and at least a second page of said prompts that provides one or more questions based on received responses.

11. The method of claim 1, wherein one or more responses to said prompts are set to a default value, said default value changeable by the user.

12. The method of claim 1, further comprising one or more default assumptions, said assumptions changeable by the user, and at least one of said assumptions being made based on one or more said received responses.

13. The method of claim 12, wherein said assumptions include one or more of the following: cost of health insurance, cost to replace what the client does at home, marginal or effective tax rates, tax deductions, and yearly personal expenses.

14. The method of claim 1, wherein one or more of said prompts are dynamic, said dynamic prompts presented in response to one or more said received responses.

15. A computer system for providing an interactive client session to facilitate the selection of a customized risk abatement life insurance program, the system comprising:
a query unit programmed for presenting one or more prompts related to life insurance, each prompt being associated with a blank field or two or more response choices, and for receiving a response for each of the said one or more prompts;
an assessment unit operatively connected to and in communication with the query unit for calculating one or more needs assessment values, with a computer processor, based on the responses to said prompts; and
a recommendation unit for recommending one or more life insurance packages based on said needs assessment values.

16. The system of claim 15, wherein said prompts related to life insurance comprise questions relating to at least one of a client's, present or future, expenses or earnings.

17. The system of claim 15, wherein said one or more life insurance packages comprises an amount of coverage and the projected monthly cost for obtaining said amount of coverage.

18. The system of claim 17, wherein said one or more needs assessment values are calculated by category, said categories comprising one or more of the following: cost to pay off debt, cost of children's education, cost to pay off mortgage, cost to provide ongoing living expenses, and final expenses.

19. The system of claim 15, wherein said recommendation unit recommends at least one full-protection package, and at least one package less expensive than said full-protection package.

20. The system of claim 19, wherein said recommendation unit presents to the user what each said recommended one or more life insurance package covers.

21. The system of claim 20, wherein said recommendation unit presents an estimate of the amount each said covered item will cost to be covered.

22. The system of claim 15, wherein less than 35% of said prompts likely require a user to estimate a number.

23. The system of claim 15, wherein said prompts do not include prompts likely to require a user to estimate a number.

24. The system of claim 15, wherein said query unit presents a first page of said prompts to provide filtering questions, and at least a second page of said prompts to provide questions based on received responses.

25. The system of claim 15, wherein one or more responses to said prompts are set to a default value, said default value changeable by the user.

26. The system of claim 15, further comprising one or more default assumptions, said assumptions changeable by the user, and at least one of said assumptions being made based on one or more said received responses.

27. The system of claim 26, wherein said assumptions include one or more of the following: cost of health insurance, cost to replace what the client does at home, marginal or effective tax rates, tax deductions, and yearly personal expenses.

28. The system of claim 15, wherein one or more of said prompts are dynamic, said dynamic prompts presented in response to one or more said received responses.
